(19) United States
(12) Patent Application Publication
(10) Pub. No.: US 2020/0364278 A1
(43) Pub. Date: Nov. 19, 2020

(54) DATA PROCESSING SYSTEM AND METHOD FOR PERSONALIZATION OF A VEHICLE SEARCH TOOL

(71) Applicant: Fair IP, LLC, Santa Monica, CA (US)

(72) Inventors: Abhishek Barnwal, Santa Monica, CA (US); Clayton Maxwell Schoeny, Marina dei Rey, CA (US)

(21) Appl. No.: 16/874,413

(22) Filed: May 14, 2020

Related U.S. Application Data
(60) Provisional application No. 62/849,573, filed on May 17, 2019.

(51) Int. Cl. G06F 16/9535; G06Q 30/02; G06Q 30/06

(52) U.S. Cl. CPC G06F 16/9535; G06Q 30/0201; G06Q 30/0631; G06Q 30/0625; G06Q 30/0204

(57) ABSTRACT

Systems, methods and products for cold start customization of a vehicle data system. In response to a consumer request to access a search tool, the consumer is identified and if there is no associated historical search information, a cold start customization process is performed. In this process, demographic information for the consumer is retrieved and used to identify specific groupings within several demographic categories which correspond to the consumer demographic information. The system then access a list which stores vehicle preferences for each possible demographic classification and retrieves the specific vehicle preferences (e.g., top-ranked vehicles for consumers in each classification) which correspond to the consumer's demographic classification. The system then generates a cold start search for the consumer which is customized according to the retrieved set of vehicle preferences corresponding to the consumer's identified demographic classification (e.g., includes the top-ranked vehicles for that classification).

### RELATED APPLICATIONS

This application claims priority under 35 U.S.C. § 119(e) to United States Provisional Patent Application No. 62/849,573, entitled “DATA PROCESSING SYSTEM AND METHOD FOR PERSONALIZATION OF A VEHICLE SEARCH TOOL”, filed May 17, 2019, which is fully incorporated herein by reference for all purposes.

### TECHNICAL FIELD

The present disclosure relates generally to the field of data processing systems and methods and more particularly to data processing systems and methods for personalizing (customizing) a search tool that facilitates interactions between a consumer and an automotive data processing system in relation to searches for items such as vehicles.

### BACKGROUND

Internet-based systems and other networked computer systems that facilitate purchasing (buying or leasing) automobiles have become increasingly important tools for both consumers and dealers. For example, vehicle search services provided through the Internet have revolutionized the process of searching for vehicles. Dealer management systems (DMS) have also become available for the management of finance, sales, parts, inventory and other aspects of running a dealership.

The process of purchasing a vehicle through a dealership typically involves several distinct steps including: i) vehicle search and selection, ii) a test drive, iii) price negotiation, iv) third party loan approval, v) selection of financing and insurance (F&I) options, and vi) document generation and execution. In a typical scenario, a consumer looking to purchase a vehicle wanders dealer lots or uses the various different web sites that may be provided by dealers and third parties to locate vehicles of interest. If the consumer finds a vehicle that they wish to purchase, they will typically have to finance the vehicle and may therefore have to go to a bank or use the bank's web site to apply for a loan. The consumer may alternatively choose to finance the vehicle through the dealer's sales desk or F&I department, in which case the dealer will interact with one or more loan providers to submit loan applications for the consumer.

The market for vehicles is very large, with many different vehicles available to be purchased, and many different consumers who are searching for desired vehicles. Many search tools are standardized and are presented in the same way to all of these different consumers. These tools do not address the differences between consumers and consequently fail to provide the additional assistance to the consumers that may be available through personalization/customization of the search tool based on each consumer's specific interests, needs and circumstances.

### SUMMARY

One of the objectives of an automotive data processing system is to present to consumers vehicles that they are likely to find desirable. Since different consumers have different needs, different desires and different circumstances, this may involve personalizing search tools so that each consumer's search is more efficient and more likely to discover vehicles that the consumer is interested in purchasing.

In one embodiment of an automotive data processing system, a search page that is presented to a consumer through a client application is personalized in several different ways according to information associated with that consumer. When the consumer first uses the search page, there is no historical search activity for the consumer that can be used as the basis for customizing the search page. Consequently, this embodiment uses demographic information associated with the consumer to identify one or more vehicles or vehicle types that can be initially presented with the search page. If the consumer selects one of the presented vehicles or vehicle types, the system can identify vehicles that are similar to the selected vehicle and can present these vehicles to the consumer. Once the consumer interacts with the search page (e.g., by viewing one or more of the presented vehicles, selecting one or more of the presented vehicles as favorites, etc.), the consumer's interactions (browsing history) can be used to identify vehicles that the consumer is more likely to find desirable, and these vehicles can be presented to the consumer.

One embodiment comprises a method for cold start customization of a vehicle data system. In response to a request by a consumer to access the system, the consumer associated with the request is identified (e.g., through the use of the login and/or authentication of the consumer. The vehicle data system may execute a cold start phase in response to the request if the system determines that it has no historical search or browsing information associated with the consumer. If, on the other hand, the vehicle data system determines that it does not have such stored historical search/browsing activity for the identified consumer, the cold start phase of the vehicle data system may be bypassed in favor of a customization process that is based on the stored information on the consumer's search/browsing activity.

In the cold start phase, the vehicle data system retrieves demographic information corresponding to the identified consumer who is accessing the system. For each of one or more demographic categories (e.g., age, location, FICO score, income, and gender), the system identifies which one of a set of groupings within the category is associated with the identified consumer's demographic information. In this manner, the system identifies a specific demographic classification corresponding to the identified combination of groupings. The system then retrieves a set of vehicle preferences corresponding to the identified demographic classification. The system then generates a cold start page responsive to the consumer's request to access the vehicle data system, where the cold start page is customized to include at least a portion of the retrieved set of vehicle preferences corresponding to the identified demographic classification.

In some embodiments, the method may include generating a set of vehicle preferences corresponding to each of the different demographic classifications and storing the generated sets of vehicle preferences in a retrievable list with the corresponding classifications. The vehicle preferences may be generated, for example, by collecting a set of data for a general population of consumers, segregating the collected data according to each possible demographic classification, analyzing the collected data corresponding to each demographic classification, determining a set of vehicle preferences corresponding to each demographic classification, and storing the vehicle preferences corresponding to each demographic classification in a retrievable list. The vehicle preferences for each demographic classification may comprise a set of top-ranked vehicles, vehicle types, vehicle characteristics, or the like which are preferred by consumers that have the corresponding demographic classification.

One alternative embodiment comprises a system having a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a high level block diagram illustrating the structure of an automotive data processing system in accordance with one embodiment.

FIG. 2 is a flow diagram illustrating the phases of personalization of an automotive data processing system in accordance with one embodiment.

FIG. 3 is a flow diagram illustrating a method for identifying vehicles to present to a consumer in a cold start page in accordance with one embodiment.

FIG. 4 is a flow diagram illustrating a method for generating a list of vehicles of interest for a set of consumer classifications in accordance with one embodiment.

FIG. 5 is a flow diagram illustrating a method for generating a set of vehicles of interest for a consumer based on browsing history of the consumer in accordance with one embodiment.

FIG. 6 is a diagram illustrating a distributed network computing environment in which some embodiments may be implemented.

### DETAILED DESCRIPTION

The invention and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

The present disclosure relates to systems, methods and products for enabling an automotive data processing system to identify one or more vehicles of interest to a consumer who has not yet accessed the system and has not yet provided any input for viewing or selecting any vehicles. This is the first part of a larger process that may include inventory selection, financing qualification and document generation. The present disclosure focuses on the inventory selection aspects of the system and the personalization of a search page that is presented to a consumer to facilitate selection of one or more vehicles which the consumer may be interested in purchasing.

In exemplary embodiments, the system facilitates selection of a vehicle by using information associated with the consumer to identify a demographic group for the consumer. Based on collected usage information (historical search activity) for that group, the system can identify one or more vehicles vehicle types that have proven to be attractive to others in the same demographic group. These vehicles or vehicle types can be presented (e.g., as links to searches for these vehicles) as a “cold start” page. One or more inventory vehicles can then be displayed to the consumer, depending upon the consumer's selection of one of the displayed links. For example, the system may identify vehicles that are similar to the selected vehicle, and may display these vehicles in response to the consumer's selection. As the consumer interacts with the system and develops a browsing history, vehicles that are identified as likely vehicles of interest can be identified (based on views, likes, etc.) and displayed to the consumer.

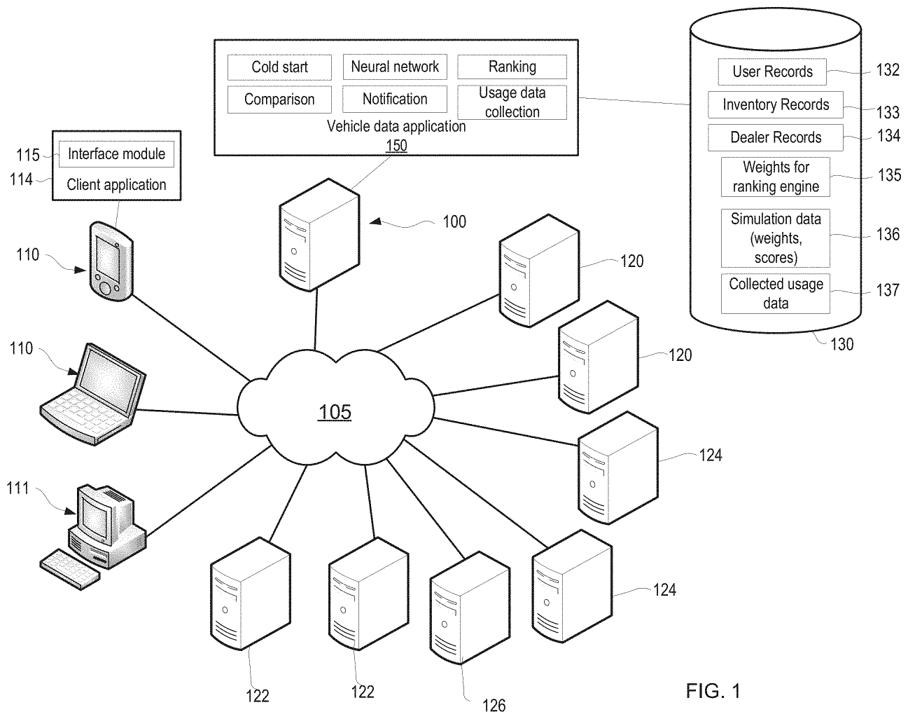

One embodiment of the automotive data processing system may be implemented in a network topology as illustrated in FIG. 1. This figure depicts the exemplary topology as a high level block diagram. The network topology of FIG. 1 comprises an automotive data processing system 100 which is coupled through network 105 to client computing devices 110 (e.g. computer systems, personal data assistants, smart phones or other client computing devices). Network 105 may be, for example, a wireless or wireline communication network such as the Internet or wide area network (WAN), publicly switched telephone network (PSTN) or any other type of communication link. The system may further include one or more information provider systems 120, one or more dealer management systems (DMS) 122, inventory systems 124, department of motor vehicles (DMV) systems 126 or other systems.

Automotive data processing system 100 may provide a comprehensive computer system for automating and facilitating a purchase process including inventory selection, financing qualification, document generation and transaction finalization, as described in detail in U.S. Patent Application Pub. No. 2018/0204281, which is hereby incorporated by reference. The present disclosure focuses primarily on aspects of the system involving inventory selection, and more particularly components of the system relating to the personalization of a displayed search page that is presented to a consumer, both at a cold start and as the consumer develops a browsing history that can be used to tailor recommendations for the consumer.

Using a client application 114 executing on a client device 110, a consumer user may access the automotive data processing system to search for inventory vehicles. The consumer may also apply for financing, review and execute documents related to the purchase of the vehicle, execute automated clearing housing (ACH) transactions, and performs various other functions through automotive data processing system 100 to purchase the vehicle from a dealership.

Turning briefly to the various other entities in the topology FIG. 1, dealers may use a dealer management system (“DMS”) 122 to track or otherwise manage sales, finance, parts, service, inventory and back office administration needs. Since many DMS 122 are Active Server Pages (ASP) based, data may be obtained directly from a DMS 122 with a “key” (for example, an ID and Password with set permissions within the DMS 122) that enables data to be retrieved from the DMS 122. Many dealers may also have one or more web sites which may be accessed over network 105, where inventory and pricing data may be presented on those web sites.

Inventory systems 124 may be systems of, for example, one or more inventory polling companies, inventory management companies or listing aggregators which may obtain and store inventory data from one or more of dealers (for example, obtaining such data from DMS 122). Inventory polling companies are typically commissioned by the dealer to pull data from a DMS 122 and format the data for use on websites and by other systems. Inventory systems 124 may provide information on inventory vehicles that is used in the ranking of the vehicles when they are presented to a consumer, such as prices of the vehicles and locations of the vehicles.

DMV systems 126 may collectively include systems for any type of government entity to which a user provides data related to a vehicle. For example, when a user purchases a vehicle it must be registered with the state (for example, DMV, Secretary of State, etc.) for tax and titling purposes. This data typically includes vehicle features (for example, model year, make, model, mileage, etc.) and sales transaction prices for tax purposes. Additionally, DMVs may maintain tax records of used vehicle transactions, inspection, mileages, etc.).

Information provider systems 120 may be systems of entities that provide information used in approving a user or purchase. Examples of information provider systems 120 may include computer systems controlled by credit bureaus, fraud and ID vendors, vehicle data vendors or financial institutions. A financial institution may be any entity such as a bank, savings and loan, credit union, etc. that provides any type of financial services to a participant involved in the purchase of a vehicle. Information provider systems 120 may comprise any number of other various sources accessible over network 105, which may provide other types of desired data, for example, data used in identity verification, fraud detection, credit checks, credit risk predictions, income predictions, affordability determinations, residual value determinations or other processes.

Automotive data processing system 100 utilizes interfaces configured to, for example, receive and respond to queries from users at client computing devices 110, interface with information provider systems 120, DMS 122, inventory systems 124 and DMV systems 126, obtain data from or provide data obtained or determined by automotive data processing system 100 to any of information provider systems 120, DMS 122, inventory systems 124, DMV systems 126. It will be understood that the particular interface utilized in a given context may depend on the functionality being implemented by automotive data processing system 100, the type of network utilized to communicate with any particular entity, the type of data to be obtained or presented, the time interval at which data is obtained from the entities, the types of systems utilized at the various entities, etc. Thus, these interfaces may include, for example, web pages, web services, a data entry or database application to which data can be entered or otherwise accessed by an operator, APIs, libraries or other type of interface which it is desired to utilize in a particular context.

Client computing devices 110, 111 may comprise one or more computer systems with central processing units executing instructions embodied on one or more computer readable media where the instructions are configured to interface with automotive data processing system 100. A client computing device 110, 111 may comprise, for example, a desktop, laptop, smart phone or other device. According to one embodiment, a client computing device 110 is a mobile device that has a touchscreen display and relies on a virtual keyboard for consumer data input. Client application 114 may be a mobile application (“mobile app”) that runs in a mobile operating system (e.g., Android OS, iOS), and is specifically configured to interface with automotive data processing system 100 to generate application pages for display to a consumer. In another embodiment, the client application 114 may be a web browser on a desktop computer or mobile device. A client computing device 111 may run an application through which a dealer portal can be accessed.

In accordance with one embodiment, a consumer can utilize client application 114 to register with automotive data processing system 100, view inventory, select a vehicle, apply for financing, review documents and finalize a sales transaction through a low friction mobile app running on a smart phone. Client application 114 can be configured with an interface module 115 to communicate data to/from automotive data processing system 100 and generate a user interface for inputting one or more pieces of information or displaying information received from automotive data processing system 100. In some embodiments, the application 114 may comprise a set of application pages through which application 114 collects information from the consumer or through which client application 114 populates with data provided via an interface 160. Application 114 may collect information that is manually input by the consumer so that it can be processed by automotive data processing system 100 with other information associated with the consumer. This information can be used to determine, for example, the consumer's qualification for a vehicle purchase, financing options available to the consumer, or pricing for particular vehicles. Application 114 may also collect automatically usage information 137 associated with the consumer's views of displayed vehicles and identification of particular vehicles as favorites or subscribed vehicles. This information may be used to tune the weights that are applied to signals input to a ranking engine that determines an order in which vehicles are displayed to the consumer.

Vehicle data application 150 can comprise a set of processing modules to process obtained data or processed data to generate further processed data. Different combinations of hardware, software, and/or firmware may be provided to enable interconnection between different modules of the system to provide for the obtaining of input information, processing of information and generating outputs.

In the embodiment of FIG. 1, vehicle data application 150 includes modules for various functions, such as cold start, neural network, ranking, tuning, usage data collection, comparison, and notification, among others. Vehicle data application 150 may also include various other modules which are not described in detail herein. These modules may include, for example, dealer interaction modules, user interaction modules, inventory modules, order modules, financing modules, document modules, and various other modules that may be necessary or desirable to perform the functions of the vehicle data application. Vehicle data application 150 may store and access data in a data store 130. Such information may include, for example, user records 132, inventory records 133, dealer records 134, weighting data 135, simulation data 136 and usage data 137.

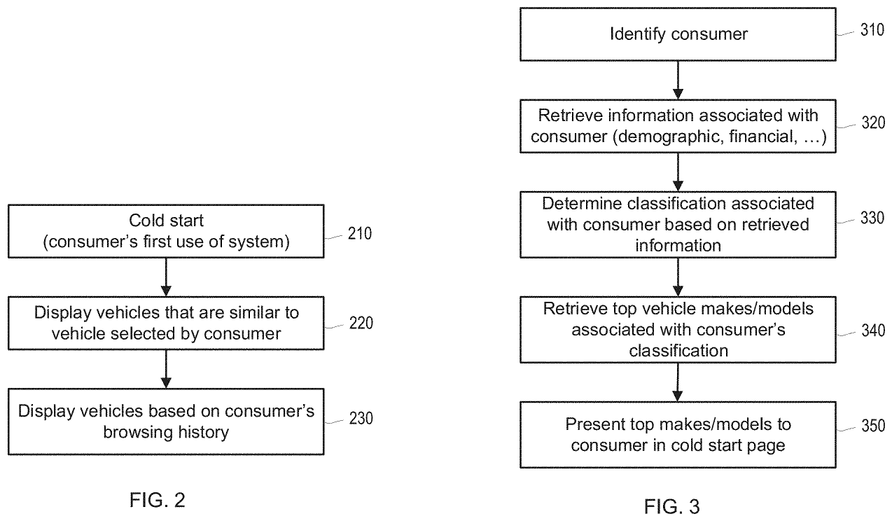

Referring to FIG. 2, automotive data processing system 100 can be viewed as operating in three phases with respect to the personalization of client application 114 for a particular consumer. In a first phase 210, in which the consumer first uses the application, the system has no historical search activity (e.g., from browsing vehicles in the system) browsing or other usage information for the consumer. In this cold start phase, the application is personalized based on information associated with the user and usage data for other consumers with similar demographics, and the consumer is presented with several choices (vehicles or vehicle types) in which the demographically similar consumers have shown interest. In a second phase 220, after the consumer chooses one of the vehicles or vehicle types that was presented in the cold start phase (or otherwise identifies a vehicle), the system identifies a set of vehicles similar to the one selected by the consumer, and presents these similar vehicles to the consumer. In the course of viewing the similar vehicles presented to the consumer in the second phase, browsing history will be generated for the consumer (e.g., the consumer will select and view various ones of the vehicles and may identify one or more as favorites). The system will collect data corresponding to this browsing history and, in the third phase 230, the system may present vehicles that are identified and potentially ranked based on the preferences indicated by the consumer's browsing history. Any preferences expressly indicated by the consumer may also be taken into account when personalizing the displayed vehicles in this phase.

In an exemplary embodiment, the system facilitates selection of a vehicle beginning in the cold start phase. This is done by using information associated with the consumer to identify a demographic group for the consumer, and then customizing a cold start page that is presented to the consumer based on the demographic group to which the consumer belongs. Using collected information for that demographic group, the system can identify one or more vehicles vehicle types that have proven to be attractive to others in the same group. These vehicles or vehicle types can be included (e.g., as links to searches for these vehicles) in the cold start page that is presented when the consumer first uses the system to look for a vehicle. One or more inventory vehicles can then be displayed to the consumer, depending upon the consumer's selection of one of the displayed links. For example, the system may identify vehicles that are similar to the selected vehicle, and may display these vehicles in response to the consumer's selection. As the consumer interacts with the system and develops a browsing history, vehicles that are identified as likely vehicles of interest can be identified from this information (based on views, likes, etc.) rather than only their demographic information and displayed to the consumer.

Referring to FIG. 3, a flow diagram is shown illustrating the cold start phase in accordance with one embodiment. As noted above, this phase corresponds to the initial use of the system by a specific consumer to search for vehicles that the consumer may wish to purchase. It is assumed that the consumer will have applied for access to the system at this point, and will have provided certain types of information through the application process. In some embodiments, some consumer information may also be obtained through other means (e.g., the consumer's location may be determined by identifying the IP address from which the consumer accesses the system).

In this embodiment, the system first identifies the consumer (310). The system may, for example, require that the consumer log in to the system and may use the login or similar information to identify the consumer. If the consumer has previously used the system to view vehicles, the system may have stored browsing history or accumulated other vehicle preference information expressed by the consumer that would provide the basis for selecting vehicles to present to the consumer at login. In this case, the cold start phase would be bypassed. If, however, the consumer has not yet used the system and has not expressed any vehicle or feature preferences, the system would proceed with the cold start.

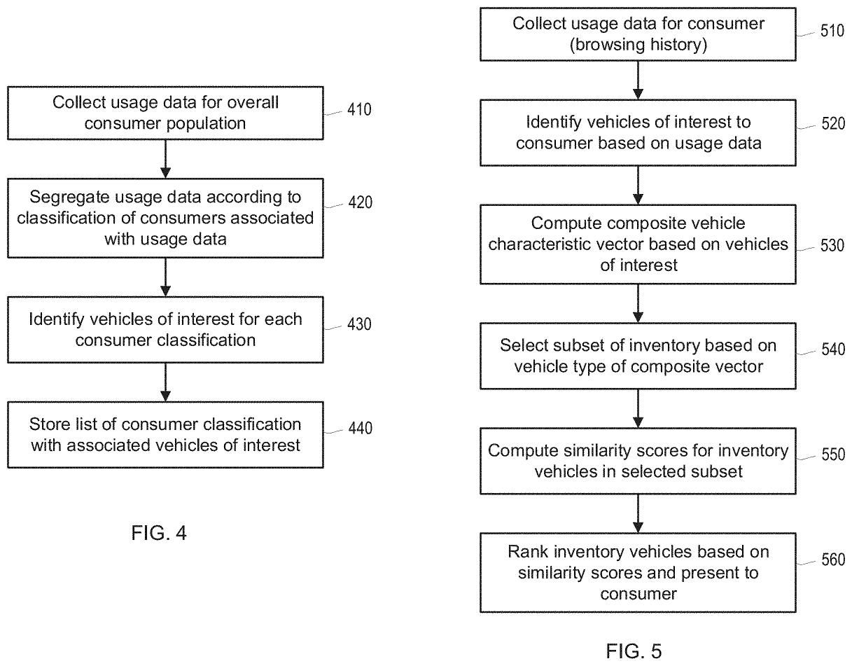

If the cold start is used, the identifying information for the consumer is then used to retrieve demographic information for the consumer. In some embodiments, this information may have been previously obtained in the application process and stored in the system's data store (320). This information may include, for example, the consumer's age, location, income, gender and FICO score. Using the information associated with the consumer, the system identifies a classification for the consumer (330). The classification is a grouping of consumers according to selected demographics which, in one embodiment, is based upon five demographic factors: age; location; FICO score; income; and gender. The demographic classification of consumers will be described in more detail below. When the classification of the consumer has been determined, the system uses this classification to retrieve a corresponding set of vehicles or vehicle types that have been identified as being of interest to consumers in the identified classification (340). This will be described in more detail below in connection with FIG. 4. The system then selects one or more of these identified vehicles and vehicle types and presents them to the consumer in an initial search page (350). The consumer may then select one of these vehicles and/or vehicle types in order to view vehicles of the selected type, as well as other, similar vehicles.

The demographic classifications that are used here are intended to provide a quick and efficient means for narrowing the types of vehicles that are displayed for a consumer who is a first-time user of the system. Since consumers within particular demographic groupings tend to be interested in similar types of vehicles, this classification mechanism can be effective in providing a selection of vehicles in which the consumer is likely to be interested, even without having any browsing history or expressed vehicle preferences for the consumer.

As noted above, the demographic classification in one embodiment uses the factors or categories of age, location, FICO score, income and gender. Each of these categories is broken down into two or more groupings or “buckets” that cover different ranges of values within the respective categories. Each consumer that uses the system will fall into one of these groupings according to their associated information. For example, the groupings under the category “age” may be: less than 25; 25-34; 35-44, 45-54; and over 55. Each consumer that uses the system will fall into one of these groupings within the age category. Consumers in each of these groupings may be likely to be interested in a corresponding type of vehicle. For example, the less-than-25 age group may tend to be more interested in economy vehicles, while the 45-54 age group may be more interested in luxury vehicles. Other age groups may likewise tend to be more interested in types of vehicles that are characteristic of those particular groupings.

The other categories are also broken down into different groupings that are each associated with corresponding vehicle types that are of interest. The FICO-score and income categories, like age, are broken down into ranges of values. In one embodiment, each of these categories is broken down into four ranges that cover all of the values that are possible for a consumer. For instance, since FICO scores may range from 300 to 850, the FICO score category may be subdivided into the groupings 300-499, 500-599, 600-699, and 700-850. The income category may be subdivided into the groupings less than $50,000, $50,000-$99,999, $100,000-$200,000, and over $200,000.

The other categories—location and gender—are divided into groupings based on non-numerical bases. In the case of gender, the groupings are male and female. In the case of location, the groupings are based on geographical characteristics associated with the consumer. In one embodiment, the location category may include two groupings that are characterized by different vehicle interests, such as “urban” and “rural”. In this example, urban consumers may be more likely to be interested in compact cars, while rural consumers may be more interested in pickup trucks. It should be noted that the categories used in this example (urban, rural), as well as the groupings within each of the other categories, are exemplary and may be different in alternative embodiments.

The groupings within each category may be determined based on analyses of collected usage data. In other words, usage data (e.g., browsing history) for an entire population of users for some period of time may be viewed with respect to each of the categories in order to identify normal breaks between groupings. For instance, if all of the collected usage data is viewed with respect to the type of vehicle in which a consumer is interested as a function of age, it may be determined that vehicles of certain types are clustered together with relatively clear breaks between them at certain ages. These ages can then be used as the breaks between groupings in the age category. Similar methods can be used to identify the groupings in other categories as well.

The vehicle types that are associated with each grouping within a category may be specified in a variety of ways. In some embodiments, particular vehicle types (e.g., compact, luxury, SUV, etc.) may be identified for the grouping. In other embodiments, certain vehicle characteristics (e.g., price, fuel economy, four-wheel drive, etc.) may be identified. In still other embodiments, particular makes or models, or even specific vehicles may be identified. In some embodiments, the groupings within a category are not individually associated with preferred vehicles, types or characteristics. Instead, particular combinations of groupings from the various categories will be associated with corresponding vehicle preferences. Thus, for example, if there were two categories and each had two groupings, there would be four unique combinations of groupings. Each of these four combinations would then have associated preferences, such as a ranked list of the top five vehicles preferred by people who fall into the corresponding combination of groupings.

As noted above, the groupings of the different categories are used to identify various demographic groups of consumers. Referring to FIG. 4, an exemplary method for identifying vehicles in which each demographic group expresses particular interest is shown. The system first collects usage data associated with consumers' activity when browsing vehicle listings (410). This data is collected for a general population of consumers. (“General” is used here to refer to the fact that the data is associated with consumers who are distributed across various, and preferably all, of the groupings of the different categories.) This population is examined before the specific consumer attempts to use the system (hence the need for the cold start), so it likely does not include the specific consumer for whom the cold start customization will be generated. Even if the specific consumer is included in the population of consumers, it should be noted that the vehicle preferences used in the cold start customization are associated with the demographic groupings, rather than any individual consumer.

The usage data for the population of consumers may be collected from consumers' use of the automobile data processing system itself, or it may be received from external sources. The collected data is segregated according to the classifications of the associated consumers (420). In other words, the data is segregated so that the usage associated with a particular group of consumers (corresponding to a particular combination of category groupings) can be considered and/or analyzed, apart from other groups of consumers. The data associated with each specific group of consumers is then analyzed to identify one or more of the vehicles or vehicle types in which the consumers in this grouping have shown the most interest (430). This may be done in a variety of ways, such as assigning points to a particular vehicle or feature for each time the vehicle or feature is viewed, marked as a favorite, etc. In one embodiment, a predetermined number of vehicles or vehicle types is selected and ranked for the corresponding consumer group. Alternative embodiments may store preferred vehicle characteristics, vehicle types, or other vehicle preference information instead of a list of top-ranked vehicles. As the top-ranked vehicles for each consumer group are determined, these vehicles are stored in a list, along with an identifier of the consumer group (440). “List”, as used here, should be construed to cover lists, tables, databases, or other data structures that are capable of storing the vehicle preferences for each consumer group. This process is repeated for each of the possible consumer groupings.

In one exemplary embodiment, the age category is broken down into five groups, the location category is broken into two groups, the FICO-score and income categories are broken into four groups each, and gender includes two groups. Using these groupings of each category, there are 320 possible combinations of groupings (5×2×4×4×2=320). Each combination (classification) can be thought of as a demographic vector having five dimensions. After the collected usage data is analyzed with respect to these groupings and/or combinations of groupings, the system generates a list that identifies which vehicles (or vehicle types, or vehicle characteristics) are most popular for each of the 320 groupings. When a consumer first uses the system, the system identifies which one of these groupings includes the consumer (based on the consumer's age, location, FICO score, income and gender), accesses the list of top vehicles for each combination of consumer groupings, and retrieves the list of top vehicles for the group which is associated with that specific consumer. One or more of these vehicles (e.g., make and model) is then included in the search page that is first presented to the user in the cold start phase. For instance, the top three most popular makes/models for the group may be presented to the consumer.

When the consumer views this cold start page, they may find one of these vehicles interesting and may select the vehicle. In one embodiment, these vehicles which are presented to the consumer serve as links. When the vehicle is selected, the system presents the consumer with a listing of vehicles that are similar to the selected vehicle. In one embodiment, the vehicles that are similar to the selected vehicle are identified using a neural network that is trained using records that include information from inventory records as well as more general information describing the options that are available on various makes and models of vehicles. The training records contain verbal information that is analyzed by the neural network and used to define a vector space that numerically characterizes the features of each make and model of vehicle.

The trained neural network is used to generate and/or identify vectors that are associated with different makes and models of vehicles. For each make and model that is input to the neural network, the neural network generates a corresponding numerical vehicle characteristic vector. The vehicle makes and models are stored with their respective vectors. If a particular vehicle make and model is selected, similar vehicle makes and models can be identified by computing the dot product of the vector for the selected vehicle make/model with the vector for the comparison vehicle make/model. The computed dot product can then be used as a similarity score for the comparison vehicle make/model. This process is repeated for all of the vehicles being considered (e.g., all of the vehicles in an inventory listing), and then the vehicles are ranked according to their respective similarity scores. Wth the highest scores indicating the vehicles that are most similar to the selected vehicle.

In one embodiment, when a vehicle make/model is selected by a consumer from a cold start page, a listing of vehicles that are similar to the selected vehicle make/model is presented to the user. The listing may, for example, include a predetermined number (e.g., 10) of the vehicles that have the highest similarity scores with respect to the selected vehicle make/model. This listing may be determined in response to the consumer's selection of the vehicle, or it may be determined prior to the selection. If the similar vehicles are to be determined prior to the consumer's selection, the system will need to identify vehicles that are similar to each of the vehicles that are presented to the consumer on the cold start page. The system can then quickly retrieve the identified list of similar vehicles when the consumer makes a selection from the cold start page. If the system does not determine the similar vehicles until after the consumer's selection is made, the list of similar vehicles cannot be presented to the consumer as quickly, but this will avoid having to determine the vehicles that are similar to vehicles on the cold start page that are not selected by the consumer.

After the list of vehicles similar to the consumer's selected vehicle has been presented to the consumer, the consumer can begin to browse the vehicle listings. As the consumer browses, the system can track the browsing history, identifying vehicles that are viewed and recording vehicles in which the consumer expressly indicates interest (e.g., by marking a vehicle as a “favorite”). When the system has acquired some information for the consumer browsing history, the system can use this information to determine characteristics of the vehicles in which the consumer may be interested, and then further personalize the displays that are presented to the consumer by giving preference to vehicles that have features similar to those indicated by the browsing history.

Referring to FIG. 5, in one exemplary embodiment, the consumer's browsing history is tracked (510) to identify vehicles in which the consumer indicates an interest (520), such as by expressly indicating vehicles as “favorites”. For instance, in one scenario, a consumer initially selects a vehicle that is suggested on a cold start page and then views similar vehicles that are presented by the system in response to selection of this vehicle. As the consumer views the similar vehicles presented by the system, the consumer may select one of these vehicles as a favorite. The system may combine the vehicle characteristic vectors for these two vehicles (the vehicle initially selected on the cold start page and the favorited vehicle) to form a composite vector (530). The system may then compare the vectors of the currently available inventory vehicles to the composite vector in order to identify inventory vehicles that are most similar to the composite vector (540). Similarity scores may be generated for these vehicles to indicate their similarity to the composite vector (550), and they may be ranked according to their similarity scores and presented to the consumer (560).

If, for example, the vehicle initially selected on the cold start page is a Toyota Corolla and the favorited vehicle is a Nissan Altima, the system would retrieve the vehicle characteristic vector for the Toyota Corolla and the vector for the Nissan Altima and would compute a new composite vector that is a function of each of these vectors. In one embodiment, the system may simply average the two vectors. In another embodiment, the system may compute a weighted average of the two vectors, with greater weight being given to the favorited vehicle (the Nissan Altima in this case) because the consumer has expressly indicated interest in this vehicle. The system may also combine vectors for more than two vehicles (e.g., averaging vectors for several favorited vehicles). The resulting composite vector, although it does not directly represent a particular vehicle make and model, would be used in the same manner as a vector representing an actual make/model when determining which inventory vehicles are “similar” to the composite vehicle which it represents.

The browsing history can also be used to reduce the amount of inventory that needs to be searched by the system when identifying vehicles of interest for the consumer. For instance, in the example above, the consumer initially selected a Toyota Corolla and then favorited a Nissan Altima. If both of these vehicles are small, four-door sedans, the composite vector will also represent a small four-door sedan, and the system can make the assumption that the consumer is interested in small, four-door sedans. The system may therefore take only the subset of the inventory vehicles that are small, four-door sedans and may determine the similarity of the vehicles in this subset to the composite vector. The system thereby eliminates the need to make comparisons between the composite vehicle characteristic vector and the vectors of vehicles that are not in the selected subset (small, four-door sedans). After the system has determined the similarity of the vehicles in the selected subset to the composite vector, the system may rank the inventory vehicles according to the generated similarity scores and present the ranked vehicles to the user. Based upon the similarity of the inventory vehicles to the composite vector, it may be determined that the vehicle most similar to the composite vector is not even one of the two original makes and models (Toyota Corolla and Nissan Altima), but may be completely different (e.g., a Hyundai Sonata).

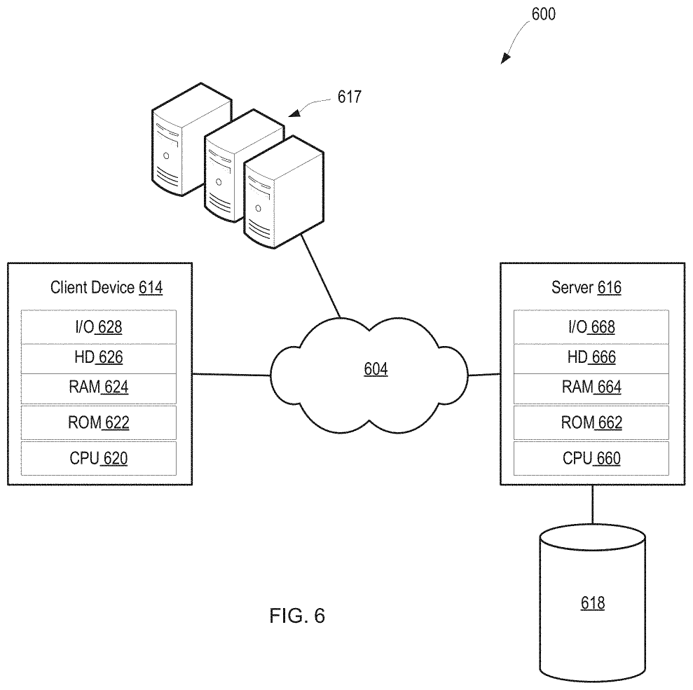

FIG. 6 depicts a diagrammatic representation of a distributed network computing environment where embodiments disclosed can be implemented. In the example illustrated, network computing environment 600 includes network 604 that can be bi-directionally coupled to a client computing device 614, a server system 616 and one or more third party systems 617. Server system 616 can be bi-directionally coupled to data store 618. Network 604 may represent a combination of wired and wireless networks that network computing environment 600 may utilize for various types of network communications known to those skilled in the art.

For the purpose of illustration, a single system is shown for each of client computing device 614 and server system 616. However, a plurality of computers may be interconnected to each other over network 604. For example, a plurality client computing devices 614 and server systems 616 may be coupled to network 604.

Client computer device 614 can include central processing unit (“CPU”) 620, read-only memory (“ROM”) 622, random access memory (“RAM”) 624, hard drive (“HD”) or storage memory 626, and input/output device(s) (“I/O”) 628. I/O 628 can include a keyboard, monitor, printer, electronic pointing device (e.g., mouse, trackball, stylus, etc.), or the like. In one embodiment I/O 628 comprises a touch screen interface and a virtual keyboard. Client computer device 614 may implement software instructions to provide a client application configured to communicate with an automotive data processing system. Likewise, server system 616 may include CPU 660, ROM 662, RAM 664, HD 666, and I/O 668. Server system 616 may implement software instructions to implement a variety of services for an automotive data processing system. These services may utilize data stored in data store 618 and obtain data from third party systems 617. Many other alternative configurations are possible and known to skilled artisans.

Each of the computers in FIG. 6 may have more than one CPU, ROM, RAM, HD, I/O, or other hardware components. For the sake of brevity, each computer is illustrated as having one of each of the hardware components, even if more than one is used. Each of computers 614 and 616 is an example of a data processing system. ROM 622 and 662; RAM 624 and 664; HD 626, and 666; and data store 618 can include media that can be read by CPU 620 or 660. Therefore, these types of memories include non-transitory computer-readable storage media. These memories may be internal or external to computers 614 or 616.

Portions of the methods described herein may be implemented in suitable software code that may reside within ROM 622 or 662; RAM 624 or 664; or HD 626 or 666. The instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

Any suitable programming language can be used to implement the routines, methods or programs of embodiments of the invention described herein. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved by distributed or networked systems. Communication or transfer (or otherwise moving from one place to another) of data may be wired, wireless, or by any other means.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

To the extent particular values are provided in any example embodiments in the description, such values are provided by way of example and not limitation. Moreover, while in some embodiments rules may use hardcoded values, in other embodiments rules may use flexible values. In one embodiment, one or more of the values may be specified in a registry, allowing the value(s) to be easily updated without changing the code. The values can be changed, for example, in response to analyzing system performance.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A method for cold start customization of a vehicle data system comprising:
in response to a request to access the vehicle data system, identifying a consumer associated with the request; and
executing a cold start phase of the vehicle data system including
retrieving demographic information corresponding to the identified consumer,
for each of one or more demographic categories, identifying one of a plurality of groupings within the category which is associated with the identified consumer's demographic information, thereby identifying a specific demographic classification corresponding to the identified combination of groupings,
retrieving a set of vehicle preferences corresponding to the identified demographic classification, and
generating a cold start page responsive to the request to access the vehicle data system, wherein the cold start page is customized with at least a portion of the retrieved set of vehicle preferences corresponding to the identified demographic classification.

2. The method of claim 1, further comprising generating a set of vehicle preferences corresponding to each of a plurality of demographic classifications and storing the generated sets of vehicle preferences in a retrievable list.

3. The method of claim 2, further comprising:
collecting a set of data for a general population of consumers;
segregating the collected data according to each possible demographic classification;
analyzing, for each demographic classification, the corresponding data and determining one or more vehicle preferences corresponding to the demographic classification; and
storing, for each demographic classification, the corresponding vehicle preferences in the retrievable list.

4. The method of claim 1, wherein the demographic categories include: age; location; FICO score; income; and gender, and wherein each of the demographic categories contains two or more distinct groupings.

5. The method of claim 1, wherein the set of vehicle preferences for each demographic classification comprises a set of top-ranked vehicles which are preferred by consumers that have the corresponding demographic classification.

6. The method of claim 1, wherein the request to access the vehicle data system comprises a user login to the vehicle data system, the method further comprising determining in response to the user login whether the vehicle data system stores historical search activity of the identified consumer, wherein retrieving demographic information corresponding to the identified consumer is performed in response to determining that the vehicle data system stores no historical search activity of the identified consumer.

7. The method of claim 6, further comprising, in response to determining that the vehicle data system stores historical search activity of the identified consumer, bypassing the cold start phase of the vehicle data system.

8. A vehicle data system having cold start customization, the system comprising:
one or more processors coupled to a non-transitory computer-readable medium that stores instructions which are executable by the processor to cause the processor to perform:
in response to a request to access the vehicle data system, identifying a consumer associated with the request; and
executing a cold start phase of the vehicle data system including
retrieving demographic information corresponding to the identified consumer,
for each of one or more demographic categories, identifying one of a plurality of groupings within the category which is associated with the identified consumer's demographic information, thereby identifying a specific demographic classification corresponding to the identified combination of groupings,
retrieving a set of vehicle preferences corresponding to the identified demographic classification, and
generating a cold start page responsive to the request to access the vehicle data system, wherein the cold start page is customized with at least a portion of the retrieved set of vehicle preferences corresponding to the identified demographic classification.

9. The vehicle data system of claim 8, wherein the instructions are further executable by the processor to cause the processor to perform:
generating a set of vehicle preferences corresponding to each of a plurality of demographic classifications and storing the generated sets of vehicle preferences in a retrievable list.

10. The vehicle data system of claim 9, wherein the instructions are further executable by the processor to cause the processor to perform:
collecting a set of data for a general population of consumers;
segregating the collected data according to each possible demographic classification;
analyzing, for each demographic classification, the corresponding data and determining one or more vehicle preferences corresponding to the demographic classification; and
storing, for each demographic classification, the corresponding vehicle preferences in the retrievable list.

11. The vehicle data system of claim 8, wherein the demographic categories include: age; location; FICO score; income; and gender, and wherein each of the demographic categories contains two or more distinct groupings.

12. The vehicle data system of claim 8, wherein the set of vehicle preferences for each demographic classification comprises a set of top-ranked vehicles which are preferred by consumers that have the corresponding demographic classification.

13. The vehicle data system of claim 8, wherein the request to access the vehicle data system comprises a user login to the vehicle data system, wherein the instructions are further executable by the processor to cause the processor to perform:
determining in response to the user login whether the vehicle data system stores historical search activity of the identified consumer, wherein retrieving demographic information corresponding to the identified consumer is performed in response to determining that the vehicle data system stores no historical search activity of the identified consumer.

14. The vehicle data system of claim 9, wherein the instructions are further executable by the processor to cause the processor to perform, in response to determining that the vehicle data system stores historical search activity of the identified consumer, bypassing the cold start phase of the vehicle data system.

15. A computer program product for cold start customization of a vehicle data system, the computer program product comprising a non-transitory computer-readable medium storing instructions executable by a processor to cause the processor to perform:
in response to a request to access the vehicle data system, identifying a consumer associated with the request; and
executing a cold start phase of the vehicle data system including
retrieving demographic information corresponding to the identified consumer,
for each of one or more demographic categories, identifying one of a plurality of groupings within the category which is associated with the identified consumer's demographic information, thereby identifying a specific demographic classification corresponding to the identified combination of groupings,
retrieving a set of vehicle preferences corresponding to the identified demographic classification, and
generating a cold start page responsive to the request to access the vehicle data system, wherein the cold start page is customized with at least a portion of the retrieved set of vehicle preferences corresponding to the identified demographic classification.

16. The computer program product of claim 15, wherein the instructions are further executable by the processor to cause the processor to perform:
generating a set of vehicle preferences corresponding to each of a plurality of demographic classifications and storing the generated sets of vehicle preferences in a retrievable list.

17. The computer program product of claim 16, wherein the instructions are further executable by the processor to cause the processor to perform:
collecting a set of data for a general population of consumers;
segregating the collected data according to each possible demographic classification;
analyzing, for each demographic classification, the corresponding data and determining one or more vehicle preferences corresponding to the demographic classification; and
storing, for each demographic classification, the corresponding vehicle preferences in the retrievable list.

18. The computer program product of claim 15, wherein the demographic categories include: age; location; FICO score; income; and gender, and wherein each of the demographic categories contains two or more distinct groupings, and wherein the set of vehicle preferences for each demographic classification comprises a set of top-ranked vehicles which are preferred by consumers that have the corresponding demographic classification.

19. The computer program product of claim 15, wherein the request to access the vehicle data system comprises a user login to the vehicle data system, and wherein the instructions are further executable by the processor to cause the processor to determine, in response to the user login, whether the vehicle data system stores historical search activity of the identified consumer, wherein retrieving demographic information corresponding to the identified consumer is performed in response to determining that the vehicle data system stores no historical search activity of the identified consumer.

20. The computer program product of claim 16, wherein the instructions are further executable by the processor to cause the processor to, in response to determining that the vehicle data system stores historical search activity of the identified consumer, bypassing the cold start phase of the vehicle data system.
